(19) United States
(12) Patent Application Publication
(10) Pub. No.: US 2007/0079237 A1
(43) Pub. Date: Apr. 5, 2007

(54) Computer system and method including an operation performed in a manner based on a determined activity

(75) Inventors: Steven R. Abrams, New City, NY (US); Bard Bloom, Yorktown Heights, NY (US); Paul Turquand Keyser, New York, NY (US); Douglas Neil Kimelman, Cortlandt Manor, NY (US); Eric Marshall Nelson, Durham, NC (US); Wendy D. Neuberger, Vestal, NY (US); Ian David Simmonds, Dobbs Ferry, NY (US); Steven Tang, Tarrytown, NY (US); Peri Lynn Tarr, Chappaqua, NY (US); John Matthew Vlissides, Mohegan Lake, NY (US); Dru Ann Vissides, Mohegan Lake, NY (US)

Correspondence Address: MCGINN INTELLECTUAL PROPERTY LAW GROUP, PLLC, 8321 OLD COURTHOUSE ROAD, SUITE 200, VIENNA, VA, 22182-3817, US

(73) Assignee: International Business Machines Corporation, Armonk, NY (US)

(21) Appl. No.: 11/243,191

(22) Filed: Oct. 5, 2005

(51) Int. Cl. G06F 3/00

(52) U.S. Cl. 715/700

(57) ABSTRACT

A computer system (and method) includes a determining device for determining an activity of a user, and a setting device for setting an operating manner of an operating device based on the determined activity.

### BACKGROUND OF THE INVENTION

1. Field of the Invention

The present invention generally relates to a computer system (and method) which includes an operating device for performing an operation and, more particularly, a system including an operation performed in a manner based on a determined activity.

2. Description of the Related Art

A great many activities, particularly creative or intellectual activities, can be divided into a number of subactivities. For example, a computer user may use a word processing application to create a document. This activity (e.g., creating a document) could be divided, for example, into subactivities such as an initial stage involving creating concepts, and cutting and pasting large sections of text, and a final stage which may include a fine-tuning of the document.

Another example of an activity that can be divided into subactivities is software engineering. As an example, in the course of designing an developing a software system, practitioners may attempt to understand the problem domain, develop scenarios or use cases that describe how the system will be used, produce models that describe the structure of the system at various levels, develop test cases which can determine if the system is behaving according to its specification, and develop, debug, deploy, and maintain the actual software.

Many of these activities have specific tools to support them. For example, there are requirements tools (such as Requisite Pro or DOORS), modeling tools (such as Rational Software Modeler or ArgoUML), development tools (such as Rational Application Developer or Microsoft Visual Studio.NET), testing tools (such as Rational Functional Tester or Eggplant), and so forth.

It has long been recognized that integration across these tools can assist practitioners in moving seamlessly across these activities, particularly in so far as data can be shared among the tools. For example, tighter integration between the modeling and development tools helps keep the models in synch with the code, allowing the developers to move among the presentations provided by each tool with little concern for whether data needs to be imported, exported, or updated. Eclipse (e.g., www.eclipse.org) is an example that has grown in recent popularity as a platform on which many disparate tools can be integrated.

It has also been recognized that integrating a large collection of tools into a single platform can result in a complicated user experience. Each tool can add its own set of views, editors, commands, and menu entries to the platform, and practitioners can be confused as to what commands to use when. It has therefore become important to be able to group the capabilities of the tools according to the activity being performed by the practitioner.

In the Eclipse platform, the notion of a “perspective” was introduced in order to address this in different ways. A perspective is, essentially, grouping of views and commands which are enabled. As an example, a user can choose the “Debug” perspective when debugging a system. This will cause the platform to configure itself with an arrangement of views, editors, and commands that the perspective designer deemed appropriate for the activity of debugging. The “Modeling” perspective would provide a different arrangement of views, editors, and commands, appropriate to the activity of modeling. This has greatly helped with the problem of clutter and confusion.

However, the amount of information presented in any given arrangement of views can still be overwhelming, particularly as the systems being designed grow in size.

### SUMMARY OF THE INVENTION

In view of the foregoing and other exemplary problems, drawbacks, and disadvantages of the conventional methods and structures, a purpose of the exemplary aspects of the present invention is to provide a system and method which may allow a user to perform an activity more efficiently and effectively than in a conventional computer system.

The present invention includes a computer system (and method) including a determining device for determining an activity of a user; and a setting device for setting an operating manner of an operating device based on the determined activity.

The operating device may include, for example, a display device for displaying data (e.g., a graph). In this case, the display device may include, for example, a software modeling application for displaying software modeling data. Further, the setting device may configure (e.g., automatically configure) a display of the data according to the determined activity. In addition, the determining device may determine that another activity is being performed and the setting device reconfigures the display according to the another activity. Further, the setting device may include a selector which selects the display from among a plurality of displays.

The setting device may include, for example, a filter for producing a filtered subset of the data according to the determined activity. In this case, the display device may display the filtered subset of the data, and the display may include a hierarchical organization area which displays the filtered subset.

In addition, the setting device may include a recommending device for recommending a manner of interacting with the data according to the determined activity. In this case, the display device may display the recommended manner of interacting with the data, and the display may include a recommendation area which displays the recommended manner of interacting with the data.

Further, the determining device may include a selector for selecting the activity from among a plurality of activities, and the display may include a menu for listing the plurality of activities. The determining device may also include an analyzer for analyzing an interaction of the user with the computer system, and outputting the determined activity based on a result of the analyzing. The determining device may also include a detector for detecting at least one of a status of the user in a process according to workflow system, and a work item that the user has taken off of a queue.

In another aspect, the operating manner may include, for example, a response to a user input, in which case, the setting device may include a selector for selecting the response to the user input from among a plurality of responses to the user input. Further, the selected response to the user input may include sending a command to another computer system which is connected to the computer system. The another computer system may include, for example, an instant messaging server, in which case, the selected response to the user input may include sending a command to the instant messaging server for controlling a visibility of the user from the server.

Another aspect of the present invention includes a computer method which includes determining an activity of a user, and setting an operating manner for an operating device based on the determined activity.

Another aspect of the present invention includes a programmable storage medium tangibly embodying a program of machine-readable instructions executable by a digital processing apparatus to perform the computer method according to the exemplary aspects of the present invention.

In still another aspect, the computer method according to the exemplary aspects of the present invention may include deploying computing infrastructure in which computer-readable code is integrated into a computing system, such that the code and the computing system combine to perform the method.

With its unique and novel features, the present invention provides a computer system and method which may allow a user to perform an activity more efficiently and effectively than in a conventional computer system.

### BRIEF DESCRIPTION OF THE DRAWINGS

The foregoing and other exemplary purposes, aspects and advantages will be better understood from the following detailed description of an exemplary embodiment of the invention with reference to the drawings, in which:

FIG. 1 illustrates a computer system 100 according to the exemplary aspects of the present invention;

FIG. 2 illustrates a computer method 200, according to the exemplary aspects of the present invention;

FIG. 3 illustrates a graphical user interface (GUI) 300 (e.g., tool user interface) which may include a hierarchical view of a model, an editor area, prototypes, recommendations, and activity menu button, according to the exemplary aspects of the present invention;

FIG. 4 illustrates a GUI having an activity menu 350, according to the exemplary aspects of the present invention;

FIG. 5 illustrates a part of the model 500 of an IT system, including some of the relation type labels, according to the exemplary aspects of the present invention;

FIG. 6 illustrates a Metamodel listing 600, including possible types of relations between types of nodes, according to the exemplary aspects of the present invention;

FIGS. 7A-7B illustrate a Viewpoints listing, according to the exemplary aspects of the present invention;

FIG. 8 illustrates a GUI 800 (e.g., tool user interface) showing a view of a model according to viewpoint for activity “Relating Components”, according to the exemplary aspects of the present invention;

FIG. 9 illustrates a GUI 900 (e.g., tool user interface) showing a view of a model according to viewpoint for activity “Deploying Components”, according to the exemplary aspects of the present invention;

FIG. 10 illustrates a GUI 1000 (e.g., tool user interface) showing view of model according to viewpoint for activity “Reviewing Component Placement”, according to the exemplary aspects of the present invention;

FIG. 11 illustrates a typical hardware configuration which may be used for implementing the computer system and method according to the exemplary aspects of the present invention; and

FIG. 12 illustrates a programmable storage medium 1200 tangibly embodying a program of machine-readable instructions executable by a digital processing apparatus to perform the computer method according to the exemplary aspects of the present invention.

### DETAILED DESCRIPTION OF EXEMPLARY EMBODIMENTS OF THE INVENTION

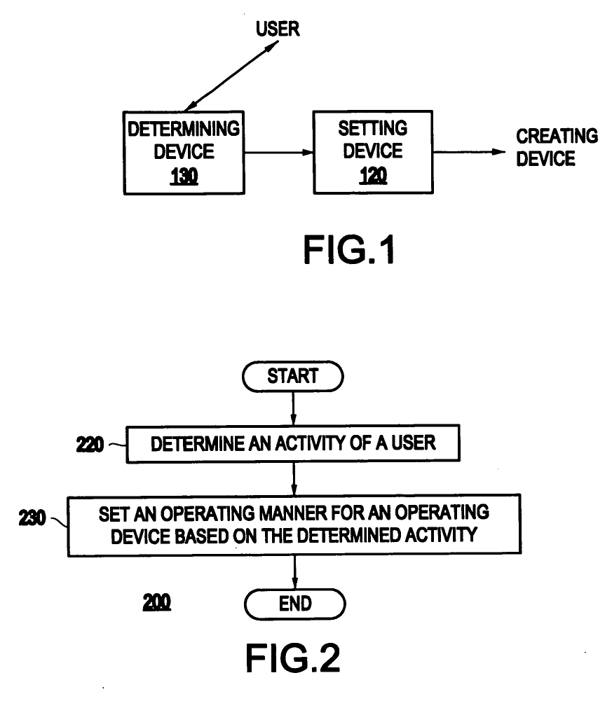

Referring now to the drawings, and more particularly to FIGS. 1-12, there are shown exemplary embodiments of the method and structures of the present invention.

Overview

The inventors of the present invention have recognized that activities (e.g., software design activities) may have within it many sub-activities, and that different filtering and arrangements of information (e.g., within the same view) may be appropriate to different sub-activities.

As an example, during the modeling sub-activity of developing a system context diagram, the details of the components comprising the system can clutter the overall project view, overwhelming and distracting the practitioner from the job at hand, which is understanding the context in which the system lives.

Model-driven development (MDD) involves expressing software in higher-level and often domain-specific terms rather than in a general-purpose programming language. Visual notations are the preferred medium of expression in MDD, and graphs are their representation of choice.

Notations such as those specified by unified modeling language (UML), for example, are implemented most generally as a graph-based repository, as opposed to a repository of trees or tables. UML's varied visual syntaxes, such as class, interaction, and use case diagrams, are not stored explicitly and separately; they are extracted from a common graph representation of the UML metamodel (e.g., meta object facility (MOF)). Extracting a view in a given syntax involves traversing the graph and interpreting its elements in light of the metamodel's semantics. The syntaxes are said to visualize the model. Thus, the graph is the model.

Graphs are compact and easily traversed, but for large-scale models graphs are not user-friendly. People are generally more comfortable viewing and navigating voluminous data when it is organized in tables or hierarchies. In particular, the more voluminous the data, the more attractive hierarchies become.

Graphs cannot grow beyond a few dozen nodes before requiring elision. Tables are not much better. Hierarchies, in contrast, scale and elide more easily and in standard ways, as seen in the tree widgets available on most graphical user interface (GUI) platforms.

Even standard visual syntaxes aren't always the best way to peruse a model. A user often needs a “bird's-eye view” to navigate the model in the course of a domain-specific activity.

Moreover, one view of a model is rarely enough. Modeling entails many domain-specific activities.

Invariably, parts of the model should be presented in different ways for different activities. In a model including dozens of finite-state automata, for example, a user should be able to view the automata by function or requirement. If there are enough automata, a hierarchical index organized by such criteria would be called for, perhaps with filtering and elision based on user preferences.

Modeling entails many such domain-specific activities. Thus, parts of the model should be presented in different ways that transcend UML and lie closer to domain concepts. Users should be able to move among these activities fluidly, letting them focus on their problems and not on the mechanics of visualization.

The concept of a view (e.g., a rational unified process (RUP) view) has long been important to the representation of an information technology (IT) system architecture to the stakeholders in a system's lifecycle. The view that each stakeholder takes with regard to the system reflects a set of concerns that the system needs to address for that stakeholder.

A viewpoint is a way of organizing the relevant system information (e.g. model elements, descriptions, specifications) with a particular view in mind. IEEE 1471-2000 defines a viewpoint as “a specification of the conventions for constructing and using a view. A pattern or a template from which to develop individual views by establishing the purposes and audience for a view and the techniques for its creation and analysis.”

Views and viewpoints may, therefore, become central to specifying a collection of work products within a software, or system, engineering methodology like the Rational Unified Process (RUP) or Method One, or an architecture framework like Zachman or The Open Group Architecture Framework (TOGAF). The contents of these work products and suggested, but generally not mandated, representational techniques are specified by the method to construct the views that reflect the concerns of stakeholders. The goals of the stakeholders are specifically addressed in customized work products, and as more stakeholders are recognized, more customized work products are defined to address their concerns.

At present, most IT system architecture documentation repositories consist of word processor files with spreadsheets and graphics that are pulled in from separate applications. The most common technique for integration and maintaining consistency across the collection of documents is still manual copy editing.

Clearly this technique of documenting IT architectures will not scale as there are always more stakeholders to be satisfied. More critically, as a system ages, unanticipated concerns and new stakeholders are likely to arise. It is often not an easy activity to derive, from existing documentation, a new view of the system that can satisfy the new concerns, even though they may be crucial to the system's future.

Underlying all these identified stakeholders and formalized sets of relevant concerns is the (sometimes tacit) idea that there is, of practical necessity, a sufficiently consistent single model of the system. If not, the system being built is unlikely to satisfy the goals of all its stakeholders. Unfortunately that model, in its entirety, is simply too complex for a single person to understand and manage through its lifecycle.

Thus, the inventors have identified the need for a system that may provide to a user a number of viewpoints, and consequently views of a model, the viewpoints being appropriate to some modeling activity (e.g., a system which may behave differently within the viewpoints during the different activities).

Detailed Discussion

Referring again to the drawings, FIG. 1 illustrates a computer system 100 according to the exemplary aspects of the present invention. The computer system 100 includes a determining device 120 for determining an activity of a user, and a setting device 130 for setting an operating manner of an operating device based on the determined activity.

FIG. 2 provides a flowchart of a computer method 200 according to the exemplary aspects of the present invention. The computer method includes determining (220) an activity of a user, and setting (230) an operating manner for an operating device based on the determined activity.

For example, the operating device may include a display device for displaying data. In this case, the setting device may configure a display of the data according to the determined activity.

In an exemplary aspect, the present invention may utilize a viewpoint which controls the internal configuration and filtering used by the set of views within a perspective. The user may select a viewpoint from among a list of viewpoints which may correspond (e.g., respectively) to a sub-activity. The system may respond by reconfiguring the filtering of information provided in the views, and, in some cases, the behaviors of the system, according to what is appropriate for the sub-activity.

Viewpoints in the present invention may include, for example, a mechanism for extracting and presenting activity-oriented hierarchies of nodes from model graphs. A viewpoint may be considered a hierarchical “slice” through the graph that is conducive to an activity in the modeling domain. A viewpoint may present a subset of the graph's nodes hierarchically, possibly repeating nodes if the graph has circularities. A viewpoint may exploit the scalability of hierarchies while adhering closely to the needs of the domain activity.

Further, a domain metamodeler may define a viewpoint with a combination of declarative and imperative constructs. The metamodeler may focus on crafting the viewpoints so that the viewpoints can work seamlessly. The implementation may produce the hierarchies lazily (e.g., slowly) and incrementally to ensure speedy display as the model evolves.

More generally, however, the present invention is not limited to display devices or software design activities, but can be applied within any tool or system framework to allow the system to be more responsive to a user's needs during a given activity.

For example, the present invention can be applied at the level of a desktop computer's operating system. Many desktop tools interrupt a user with information that might be of interest. As an example, news tickers and other tools can inform users of interesting news items or changes in status to web sites or other databases via RSS (e.g., rich site summary, RDF site summary, really simple syndication) feeds. Instant messaging tools can let a user know that a friend or colleague is trying to reach them. These sorts of tools often have many filtering options that a user can use for determining what kinds of information should interrupt them.

In practice, though, a user may want to allow interruptions of different kinds depending on what activity a user is performing. For example, when doing work related to a given project, a user may be more willing to accept interrupts from other users involved in that project, or about news items related to that project, than at other times. When doing work related to that project, a user may want to block interrupts that are unrelated to that project.

The kind of activity being performed may also impact the type of interruption that a user is willing to accept. For example, fine, detailed oriented work may warrant a tighter level of filtering than less critical activities. Currently, these tools require the user to manually change the filtering options as they change activities. It would be desirable for the user to be able to is declare the activity that they are performing, and have the tools reconfigure themselves to the appropriate behavior, such as the level of filtering and interruption allowed.

As another example, options like spelling and grammar checking in a word processing tool are helpful at some times (e.g., when a writer is converging on a final version) and distracting at others, such as when a taking high-level notes or formulating concepts. It would be desirable for the word processing tool to also reconfigure its behavior in accordance with the selected activity.

These and many other advantages may be achieved with the present invention.

Specifically, the present invention may determine an activity of a user, and set an operating manner of an operation based on the determined activity.

Software Development

One exemplary embodiment of the present invention is in a system for model-driven development, in which the system may serve as a tool for a user to view and manipulate information in the domain of Information Technology (“IT”) Systems Architecture. For the purposes of the present description, information technology may refer to IT systems architecture as defined in A standard for architecture description by R. Youngs, D. Redmond-Pyle, P. Spaas, and E. Kahan, IBM Systems Journal 38(1) 1999, p. 32-50.

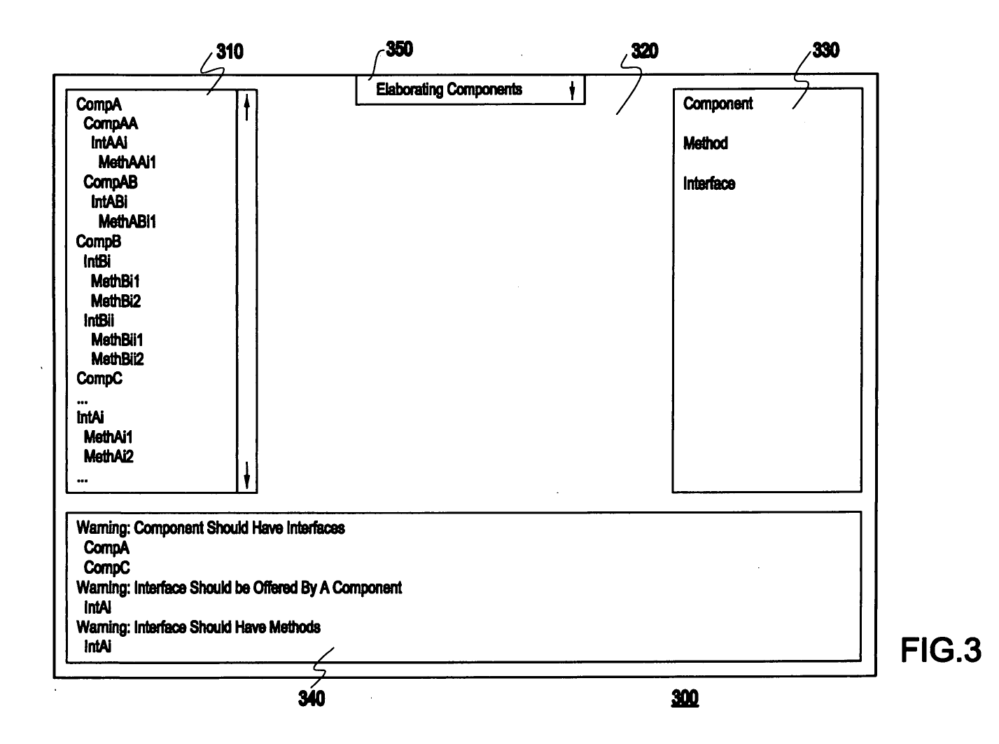

Referring again to the drawings, FIG. 3 illustrates an exemplary graphical user interface (GUI) 300 (e.g., a tool user interface, display screen, etc.), in accordance with an exemplary aspect of the present invention. The GUI 300 may include, for example an architects'workbench user interface (AWB UI) that may be used by a software architect to design software.

The GUI 300 may be generated, for example, by inputting a query. Further, the GUI 300 may be displayed by a display device of a computer system and may include, for example, a hierarchical view area 310 which may display a hierarchical view of a model (e.g., software model) 310, and editor area 320 in which may display the details of a single model element, and in which a user may edit the software model.

The GUI 300 may also include a prototype area 330 which may list prototypes (e.g., component, method, interface) which may be inserted into the software model (e.g., the hierarchical view of the model). For example, a user may use an input device (e.g., a mouse, keypad, or other input device) to control a cursor and click on “component” in the prototype area 330, and drag “component” from the prototype area 330 to the hierarchical view area 310.

Further, the “component” will be inserted in the hierarchical view of the model at a location where the user has “dropped” the component using the input device (e.g., mouse).

The GUI 300 may also include a recommendation area 340 which may display recommendations (e.g., warnings, suggestions for improving, correcting and/or completing a software model) to a user, and an activity menu button 350 which may be used to determine (e.g., select) an activity (e.g., a software model development activity) of the user. For example, when the user is performing the activity “elaborating components” the recommendation displayed in the recommendation area 340 may be different than that recommendation displayed when the user is performing the activity “relating components”, and so on.

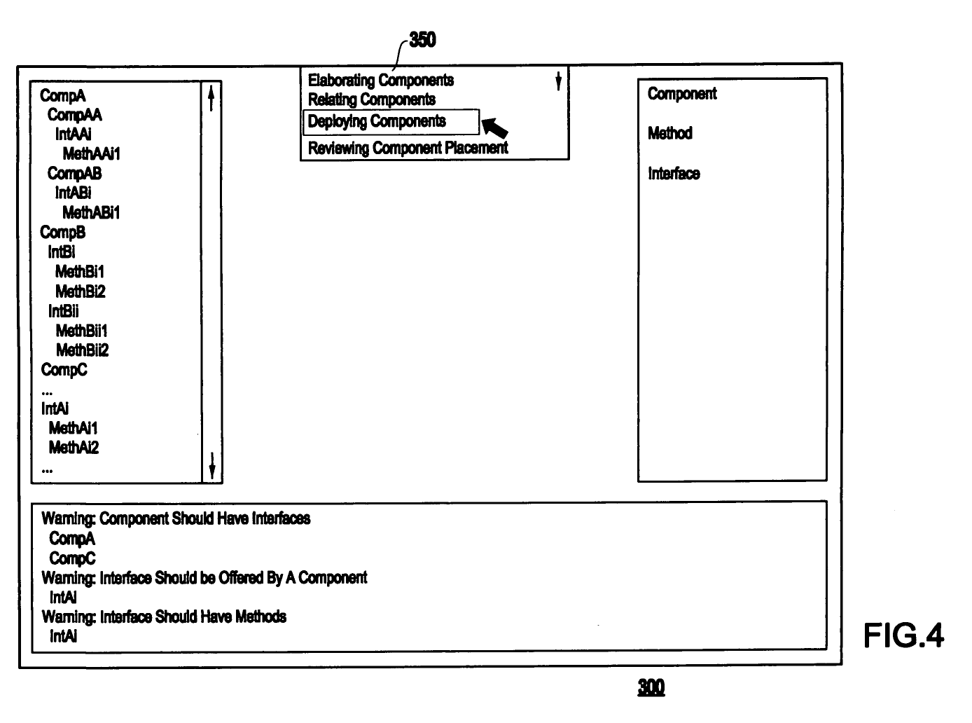

For example, as illustrated in FIG. 4, a user may use a mouse to click on the activity menu 350, in which case the menu 350 may be caused to display a list of various activities such as “elaborating components, “relating components”, “deploying components”, and “reviewing component placement”. Thus, the system may determine a user activity by the user selecting one of the activities such as “deploying components” from the activity menu 350.

In an exemplary embodiment, the graphical user interface 300 might be realized as an extension of a platform such as Eclipse, which is described in Eclipse: A Platform Becomes an Open-Source Woodstock by A. Wolfe, ACM Queue 1(8) November 2003, p. 14-16.

Further, in an exemplary aspect, the GUI 300 may have a configuration that is based on the activity of the user. Thus, for example, the hierarchical view area 310 and the recommendations area 340 may have a configuration which is based on the activity selected using the activity menu button 350.

For example, in FIG. 3, the hierarchical view area 310 of the graphical user interface 300 includes a “Relating Components” viewpoint. This viewpoint is appropriate for the activity of relating components (e.g., modeling relationships between components) which has been selected by the user as indicated by the activity menu button 350.

It should be noted that in FIG. 3 (and other drawings) that the notation “. . . ” (e.g., as used in the hierarchical view area 310) indicates content that is not illustrated for simplification.

Further, in an exemplary aspect, the interface 300 could set an operating manner (e.g., behavior) of features other than a display or in addition to a display, according to a user activity.

For example, when a user drags the “component” prototype and drops it onto a “component” in the model hierarchy (e.g., in the hierarchical view area 310), a new component may be created in the hierarchy, related to the component onto which the user dropped the prototype. The behavior of the system at that point may depend upon the activity being performed by the user.

For example, in one activity, a dialog box may be generated and displayed by the GUI 300 which asks the user whether the user intends to create a “DependsOn” or “ComposedOf” relation, whereas in another activity (e.g., an activity where only one of those types of relations is relevant), no dialog box may be generated or displayed. Instead, a relation of the sole relevant type (e.g., DependsOn) will be created (e.g., automatically created without any additional user input).

The present invention may also set (e.g., select) an operating manner (e.g., behavior) for other features based on the activity of the user. Such features may include, for example, controlling various hardware (e.g., controllers, memory devices, processors, network devices such as security devices) and software (e.g., operating systems, web browsers, and other applications). For example, if a user is performing an “elaborating components” activity, an operating manner of a security device (e.g., firewall) in a network (e.g., local area network (LAN) server may be set differently (e.g., higher security, lower security, etc.) than when the user is performing a “relating components” activity.

One feature where the present invention may be particularly useful is instant messaging.

For example, the visibility (e.g., high visibility, low visibility, selected visibility) of the user by the instant messaging server can be set differently depending upon the activity being performed by the user. For example, when a user selects an activity (e.g., switches from a viewpoint for an activity to a viewpoint for a different activity), the GUI 300 (e.g., a software modeling development tool) could send a request to the instant messaging server to make the user visible only to persons (e.g., selected instant messaging buddies) by whom the user does not mind being interrupted while performing this activity.

In addition, the system according to the exemplary aspects of the present invention may determine an activity of the user by detecting (e.g., by sensing) the activity. Thus, for example, the system may be able to automatically determine a user activity automatically without any additional user input (e.g., without requiring the user to select an activity using the activity menu button 350).

For example, the system may detect a user activity by detecting a location of the user (e.g., the user's place) in a workflow process (e.g., a step in a rational unified process (RUP)).

That is, by detecting that the user is at one location in a workflow process, the system may determine that the user is performing an “elaborating components” activity, whereas by detecting that the user is in another location, the system may determine that the user is performing a “relating components” activity.

The system may also detect a user activity by detecting work item being worked on by the user. That is, by detecting that the user is working on a work item, the system may determine that the user is performing an “elaborating components” activity, whereas by detecting that the user is working on a different work item, the system may determine that the user is performing a “relating components” activity.

Further, the system may include a memory for storing a user action history for the user (e.g., a history of the user's interaction with the computer system). The system may “analyze” the user action history and detect a user activity based on this stored history. Specifically, the system may analyze the user action history (e.g., a sequence of user actions) by using, for example, a pattern matching algorithm in order to detect and categorize patterns of the user activity and associate such patterns with one or more activities. The system may use other algorithms such as decision trees and neural networking to detect (e.g., predict) an activity being performed by the user.

Thus, for example, the system may detect a user activity by detecting patterns in the user action history. That is, by detecting that a pattern in the user action history, the system may determine that the user is performing an “elaborating components” activity, whereas by detecting a different pattern in the user action history, the system may determine that the user is performing a “relating components” activity.

For example, in a viewpoint which provides a wide variety of prototypes, if a user appears to be doing a lot of relating components to deployment units, the user is likely performing “Deploying Components” activity. That is, the actions of the user (e.g., relating components) could be detected by the system (e.g., by analyzing the stored user history), to determine that the user is performing the activity of “deploying components”, in which case, the system may set the GUI 300 to display the viewpoint for the “deploying components” activity.

In addition, upon the viewpoint being set (or reset) the system may alert a user, such as by using a visual or audible alert. For example, the system may cause a notice of the setting (e.g., resetting) to be displayed by the display device (e.g., on the GUI 300).

As another example of how the system may detect a user activity, if a user is using a drawing tool (e.g., a software tool for artists, designers, draftsmen, etc.), and the user is doing a lot of “mouse” gestures on a canvas, the tool may determine that the user is performing a “Freehand Sketching” activity and switch to a viewpoint configured appropriately for that activity. On the other hand, if the user is doing a lot of clicking on cursor keys, the tool may determine that the user is performing a “Fine Adjusting” activity, and the tool could configure itself to an appropriate viewpoint for that activity.

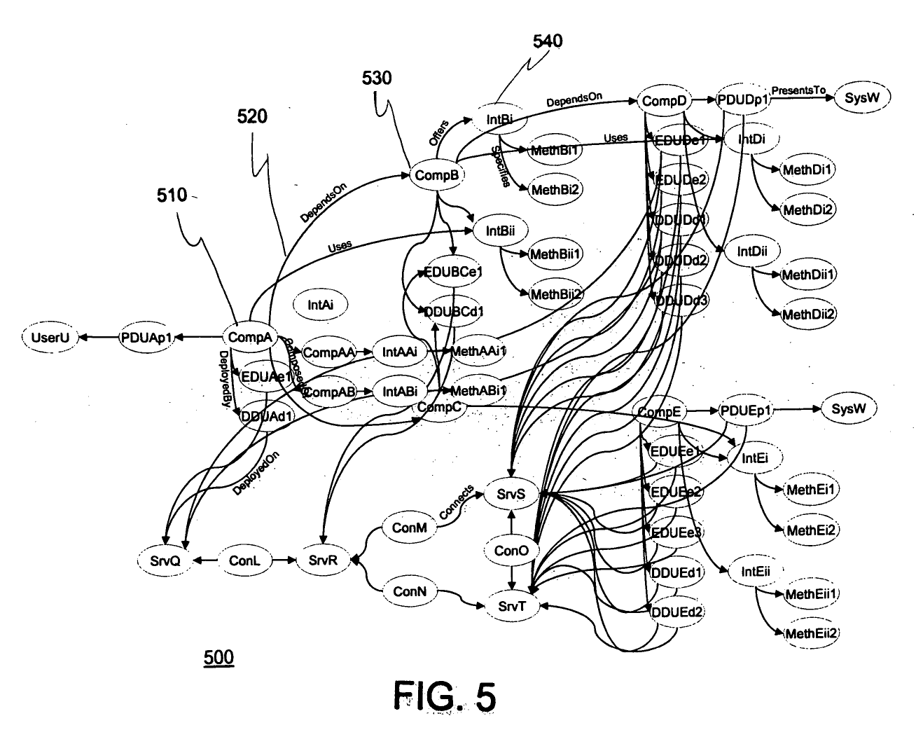

FIG. 5 illustrates a model (e.g., part of a model) 500 for an information technology (IT) system. Specifically, FIG. 5 is a “graph” (commonly referred to as a “hairball”) and illustrates some of the relation type labels that may be utilized in a software modeling tool.

In FIG. 5, the oval items indicate “nodes” in the model and the lines (e.g., arrows) indicate an “edge” between nodes. The model 500 may include various types of nodes, including, for example, users (e.g., UserU), components (e.g., CompA), servers (e.g., SrvQ), interfaces (e.g., IntBi), methods (e.g., MethBil), connectors (e.g., ConL), and so on.

An “edge” (e.g., or an “arc”) between two nodes indicates that there is some relationship (e.g., Dependson, Composedof, etc.) between the two features (e.g., components) represented by the two nodes. There can be various relationships between the items represented by the nodes, including, for example, a Component node may “depend on” another Component node, be “composed of” another Component node, “offer” an Interface node, “use” an Interface node, be “deployed by” a Deployment Unit node, and so on, as illustrated in FIG. 5.

For example, the model 500 includes a CompA node 510 (e.g., representing Component A), a CompB node 520 (e.g., representing Component B), and so on. The model 500 also includes an edge 530 indicating that Component A (represented by CompA 510) depends on Component B (represented by CompB 520).

As illustrated in FIG. 5, this manner of viewing the model of a system can be confusing. Therefore, a user may prefer to use a hierarchical view of a model (e.g., the hierarchical view 310) for software development which may be illustrated by the GUI (e.g., GUI 300) according to an exemplary aspect of the present invention. The hierarchical view may include only a portion of the model and may conveniently indicate the relationships between items in the model. For example, in the hierarchical view area 310, the Component AA (e.g., CompAA) is indented beneath Component A (e.g., CompA) to indicate that Component A is composed of Component AA.

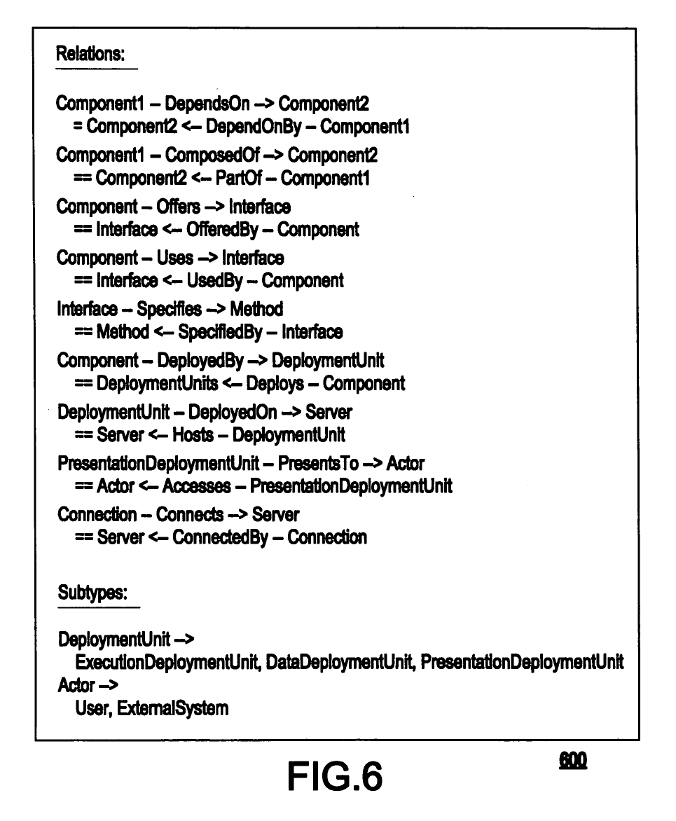

FIG. 6 provides a metamodel listing 600 which lists possible types of relations (e.g., “Dependson”, “Composedof”, etc.) between types of nodes in the metamodel and the subtypes (e.g., actor) that may be included in the metamodel. The relations, which are directed, may be read in a forward direction or a backward direction, and the listing gives the name to be used for the type of the relation, depending on the direction in which it is read.

Viewpoint Specification for Software Development

Before describing viewpoint specifications, some terms should be defined. For example, the terms “Graph” and “model” may be considered as synonymous, but the term “graph” may be favored in a technical discussion of viewpoints, whereas “model” may be favored in more domain-specific discussion. A “graph” may include nodes and relations (the latter in preference to the mathematical term “arc”). Nodes and relations may be typed.

The root of a viewpoint hierarchy, referred to as such, is not necessarily a part of the graph. Instead, the root may simply name the graph. Further, when qualified by “viewpoint” or “instance,” the terms “child,” “parent,” and “root” may refer to constituents of the viewpoint, not necessarily to extensible markup language (XML) elements that specify it. Further, the term “element” may be used to refer to XML elements exclusively.

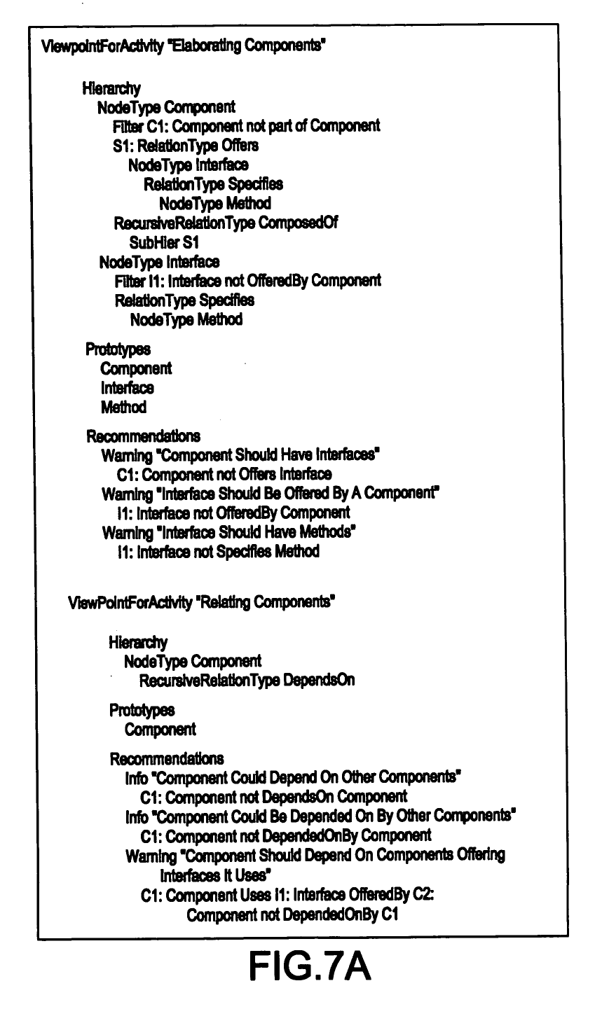

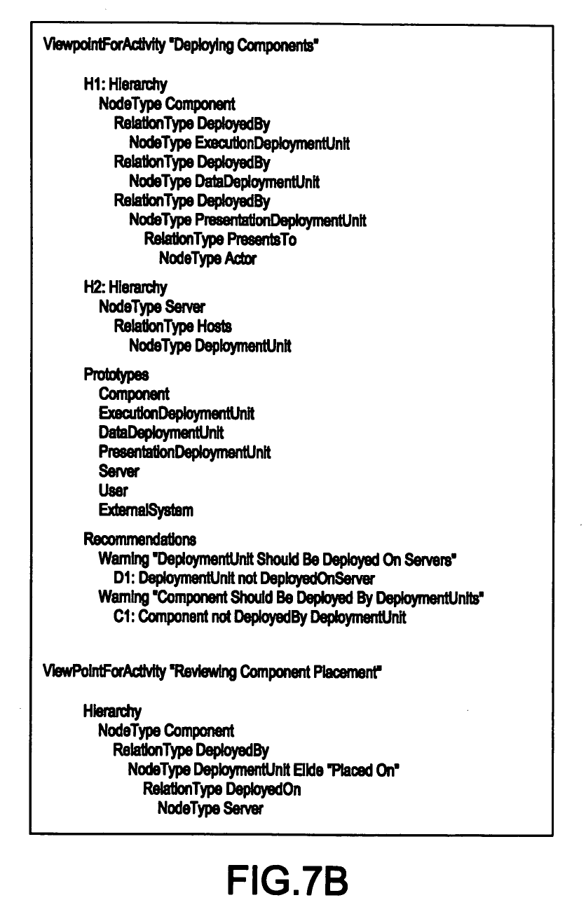

FIGS. 7A-7B provides a viewpoints listing for various viewpoints which may be displayed by a display device (e.g., GUI) according to an exemplary aspect of the present invention. That is, the system may refer to the viewpoints listing (e.g., stored in memory in the system) which is illustrated in FIGS. 7A-7B in setting a manner of displaying data to the user (e.g., displaying data on the GUI 300).

Thus, for example, as illustrated in FIG. 7A, the viewpoint for activity “elaborating components” may include “rules” for displaying the hierarchy (e.g., in the hierarchical view area 310), the prototypes (e.g., in the prototype area 330), and the recommendations (e.g., in the recommendation area 340). These “rules” may be input by a user and stored, for example, in memory in the system according to the present invention.

For example, in the viewpoint for “elaborating components”, under “Prototypes” the “rule” includes “Component”, “Interface” and “Method”. Thus, when the user is performing the activity “elaborating components”, the prototypes component, interface and method will be displayed in the prototypes area of the GUI (e.g., see prototype area 330 of GUI 300 illustrated in FIG. 3).

Further, in the viewpoint for “elaborating components”, the rule under “Recommendations” is to display “Warning: ‘Component Should Have Interfaces’” and then to display under this the components in the model which are not offering interfaces. For example, in Recommendation area 340 in FIG. 3, such components include Component A and Component C. This is also indicated in FIG. 5 which shows that neither Component A nor Component C has an “offers” relationship with an interface (e.g., compare CompA 510 with CompB 520 which have an “offers” relationship with interface IntBi 540).

Further, in the viewpoint for “elaborating components”, under “Hierarchy”, the first indented items are “NodeType Component” and “NodeType Interface”, and thus the rule is that the highest (e.g., outermost) node displayed in the hierarchical view area of the GUI (e.g., in the hierarchical view area 310 illustrated in FIG. 3) are components (e.g., Component A, Component B, etc.).

In addition, for example, the “rules” include “Filter Cl: Component not part of Component” which causes the system to examine the components in the model and display in the hierarchical area only those components which are not part of another component. The “rules” also include “S1: RelationType Offers” which may cause the system to examine the components in the model to identify the components having “offers” type relations hanging off of the component. The “rules” further state “NodeType Interface” which would cause the system to further examine those components identified to further identify those components that have an “offers” relation with an interface. The “rules” further state “RelationType Specifies” and “NodeType Method” which would cause the system to identify the “interfaces” that have a “specifies” relation with a “method”, and so on.

Thus, as illustrated in the “elaborating components” viewpoint illustrated in the GUI 300 in FIG. 3, the parts of the model which meet the “rules” of the viewpoint listing in FIG. 7A include, for example, CompA, CompAA, IntAAi and MethAAil, and so on. This is also illustrated in the graph of model 600 illustrated in FIG. 6 which indicates these particular relationships between the items represented by the nodes.

It should be noted that hierarchicalizing a graph may be difficult. Thus, in the system of the present invention, the “construction” of the viewpoint may be performed by a “lazy evaluation” of hierarchy. That is, the system may function, for example, like an incremental compiler in constructing the hierarchical view of the model.

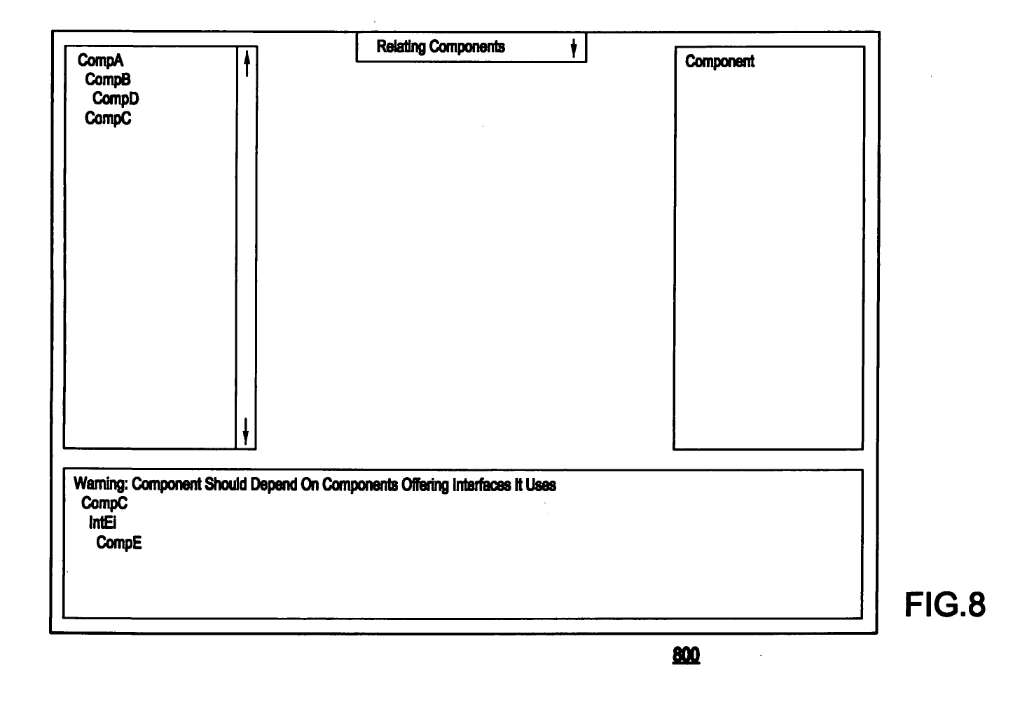

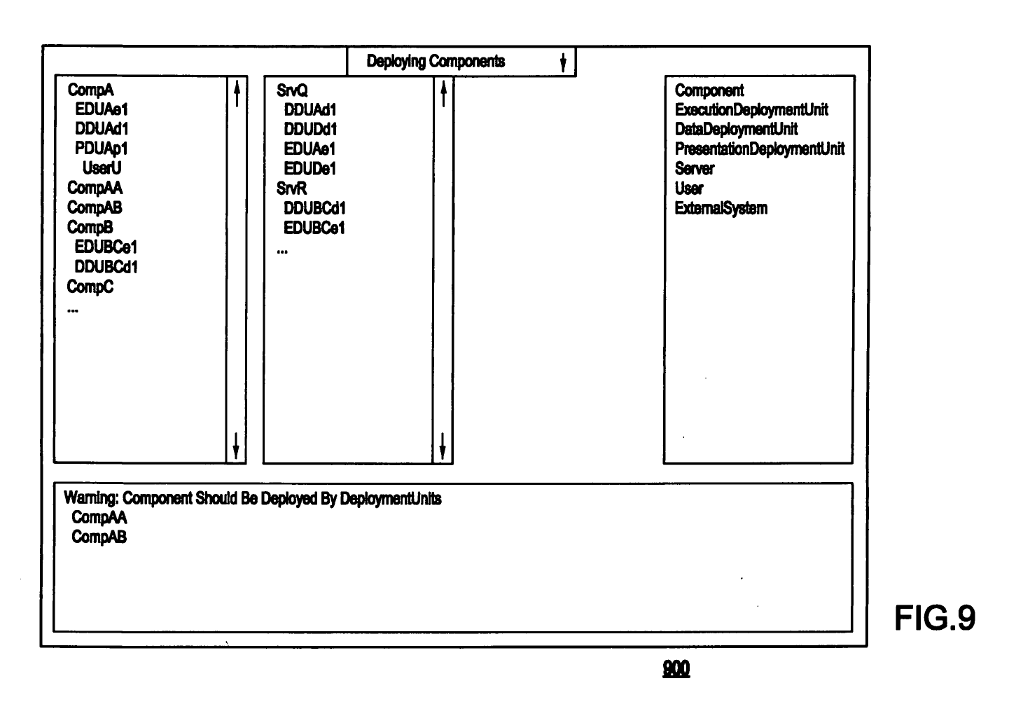

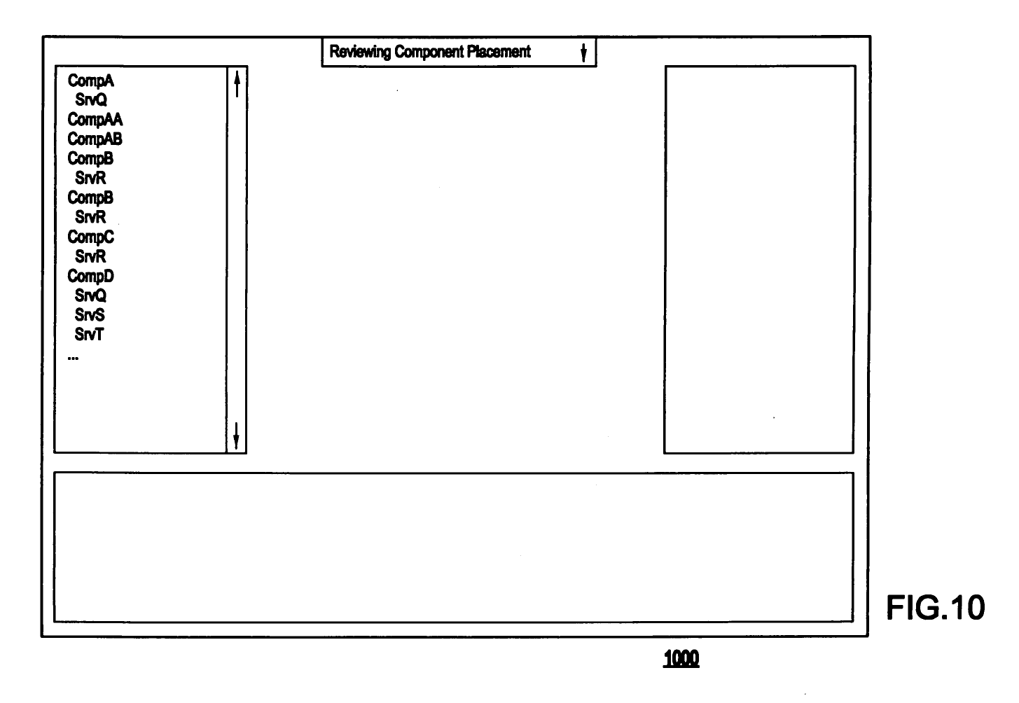

Again, an important feature of the present invention is that these “rules” for viewpoint listing may be based upon the activity being performed by the user. Thus, as illustrated in FIGS. 7A-7B, there may be separate (e.g., and different) rules for the activities “elaborating components”, “relating components”, “deploying components” and “reviewing component placement”. This is also reflected in the GUI 300 which illustrates, for example, a viewpoint for elaborating components, the GUI 800 (e.g., FIG. 8) which illustrates, for example, a viewpoint for relating components, GUI 900 (e.g., FIG. 9) which illustrates, for example, a viewpoint for deploying components, and GUI 1000 (e.g., FIG. 10) which illustrates, for example, a viewpoint for elaborating components.

Further, the present invention may include, for example, a graphical user interface which is similar to the graphical user interface discussed in U. S. patent application Ser. No. 11/134,500, (Abrams, et al., SYSTEM AND METHOD FOR GUIDED AND ASSISTED STRUCTURING OF UNSTRUCTURED INFORMATION, filed on May 23, 2005), which is commonly assigned herewith and incorporated by reference herein.

It should be noted that the term “operating manner” as used herein may be construed to include an operating manner for providing information to a user. Further, the term “operating device” may be construed to include a device which may be used to provide information to the user. The operating device may be is included in the computer system (e.g., a memory device, display device, software application stored in memory, processor, etc.) or a device which may be connected to the computer (e.g., by wire or wirelessly connected) such as over a network such as a local area network, ethernet or the Internet. Thus, for example, the operating device may include a display device (e.g., a GUI, monitor, etc.), a software development application, web browser software, email browser software, email server, instant messaging server, word processing software (e.g., MS Word, Wordperfect, etc.), LAN server, and so on.

Thus, in an exemplary aspect of the present invention, the setting device may set a manner of providing information of an information providing device based on the determined activity.

An important feature of the present invention is that it may allow a person to more efficiently and effectively control the quality (e.g., and quantity) of information provided to them while he is performing an activity. For example, a software architect may only want to receive a particular quality (e.g., type) of information when performing a given software design activity on a computer, an artist may only want to receive a particular quality of information when performing a given painting activity, an electrical engineer may only want to receive a particular quality of information when performing a given circuit design or layout design activity, and so on.

The present invention may allow these users to customize the quality of the information that they may receive (e.g., via the computer system) while they are performing a given activity.

That is, the system may select from a total quantity of information (e.g., information which may ordinarily be provided to the user), a portion of such information to provide to the user (e.g., such as by displaying such information to the user) and a portion of such information to restrict out and not forward to the user, based on the activity that the user is performing.

That is, the setting device of the present invention may include a filter which may filter out information that does not have a determined level of quality (e.g., information that is not relevant to (e.g., have some relationship to) the activity being performed by a user.

That is, the present invention may include an identifying device for identifying a quality of information that may be provided to the user. For example, this quality may be pre-identified and stored in a memory in a table. Further, this information “quality” may be stored such that it is associated with an activity. That is, “Quality X” may be associated with “Activity X”, “Quality Y” may be associated with “Activity Y”, and so on. The system may thus, refer to this table in order to determine what “quality” of information to provide to the user based on the activity being performed by the user.

For example, the viewpoint listing for an activity as illustrated in FIGS. 7A-7B may be input by a user or previously stored in a memory in a system. The viewpoint listing may identify the “quality” of information that the user may receive (e.g., be presented with by the system). For example, the viewpoint listing may provide that for a given activity (e.g., elaborating components) the information provided to a user (e.g., displayed to the user in the hierarchical view area 310 of the GUI) should have a quality (e.g., include a particular type of component, a particular type of interface, etc.) which is associated with that activity.

Further, the “quality” of information that may be associated with an activity and provided to the user may be defined, for example, as having some relationship with the activity. Thus, for example, the “quality” of the information may be such that it is helpful to the user (e.g., commonly used by the user) in performing the activity.

Another feature of the present invention is that system may include a learning (e.g., adaptive) capability such that the “quality” of information to associate with a given activity and provide to the user may be learned by the system. Thus, for example, the “quality” of information which is associated with a given activity may be adapted based on a user history.

This may be accomplished, for example, by storing the user actions and interactions with the system such as user selections, inputs, responses to system inquiries (e.g., dialogue menus), etc., and analyzing the history of user actions and interactions such as by using a neural network algorithm, pattern matching algorithm, etc. Based on this analysis, the system may update the “quality” of information that is stored in memory and associated with the activity, such that when the user next performs that activity, the updated “quality” of information may be provided to the user (e.g., displayed in a GUI).

For example, in the exemplary aspect of FIG. 7A, since the viewpoint listing for “elaborating components” includes under “Prototypes” the items “Component”, “Interface” and “Method”, when the user is engaged in that activity, those items may be displayed in the prototype area 330 of the GUI 300. However, if the user rarely uses the “Interface” item, over time the system may adapt to the user's preference by updating the “quality” of information provided to the user by deleting the “Interface” item from the prototype area 330. Similarly, for example, if the user over time continuously ignores the recommendation “Warning: Component Should Have Interfaces” displayed in the recommendation area 340 of the GUI 300, the system may update the “quality” of information to delete this recommendation so that it is no longer provided to the user in the GUI 300, and so on.

This learning capability may also allow the system to learn “activities” of the user. For example, if a user frequently engages in a particular behavior which is not associated with any particular activity stored in the system, the system may analyze the user history and based on this analysis, determine that another activity should be created. This new activity may be stored in the system (e.g., added to the viewpoint listing in FIG. 7A-7B), given a name (e.g., “Activity X) and added to the GUI (e.g., activity menu button 350 of GUI 300). The system may also allow the user to rename this activity to give it a name that more accurately describes the activity being performed.

In addition, the system may allow the user to conveniently add activities and change (e.g., manually change) the “quality” of information provided to the user for the given activities. For example, clicking on the activity menu button may cause the system to create a drop down menu which lists the activities stored in the system, and also includes a listing for “Add or Delete Activities”, on which the user can click in order to generate a new area for add and/or delete an activity in the system.

Further, clicking on a particular activity in the activity menu button on a GUI (e.g., GUI 300) may cause a submenu to be displayed next to the selected activity. The submenu may include the listings “Select Activity” and “Update Data for Activity”. If a user clicks on “Update Data for Activity” the system may cause a view to be generated and displayed to the user, which may display the viewpoint listing (e.g., FIG. 7A-7B) for that activity and allow the user to conveniently edit the viewpoint listing for that activity.

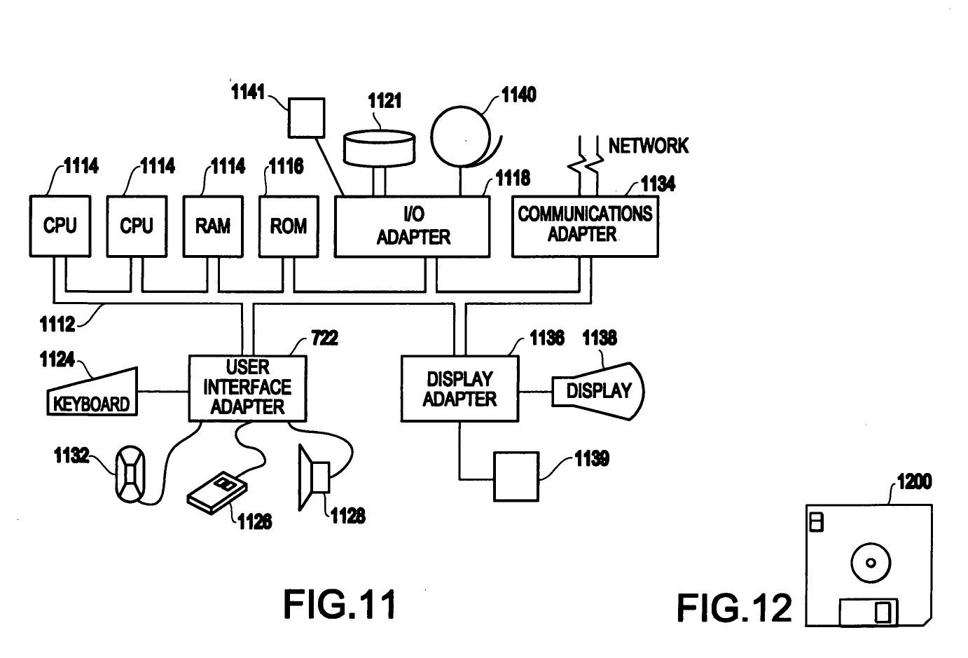

Referring again to the drawings, FIG. 11 illustrates a typical hardware configuration which may be used for implementing the computer system and method according to the exemplary aspects of the present invention. The configuration has preferably at least one processor or central processing unit (CPU) 1111. The CPUs 1111 are interconnected via a system bus 1112 to a random access memory (RAM) 1114, read-only memory (ROM) 1116, input/output (I/O) adapter 1118 (for connecting peripheral devices such as disk units 1121 and tape drives 1140 to the bus 1112), user interface adapter 1122 (for connecting a keyboard 1124, mouse 1126, speaker 1128, microphone 1132, and/or other user interface device to the bus 1112), a communication adapter 1134 for connecting an information handling system to a data processing network, the Internet, and Intranet, a personal area network (PAN), etc., and a display adapter 1136 for connecting the bus 1112 to a display device 1138 and/or printer 1139. Further, an automated reader/scanner 1141 may be included. Such readers/scanners are commercially available from many sources.

In addition to the system described above, a different aspect of the invention includes a computer-implemented method for performing the above method. As an example, this method may be implemented in the particular environment discussed above.

Such a method may be implemented, for example, by operating a computer, as embodied by a digital data processing apparatus, to execute a sequence of machine-readable instructions. These instructions may reside in various types of signal-bearing media.

Thus, this aspect of the present invention is directed to a programmed product, including signal-bearing media tangibly embodying a program of machine-readable instructions executable by a digital data processor to perform the above method.

Such a method may be implemented, for example, by operating the CPU 1111 to execute a sequence of machine-readable instructions. These instructions may reside in various types of signal bearing media.

Thus, this aspect of the present invention is directed to a programmed product, including signal-bearing media tangibly embodying a program of machine-readable instructions executable by a digital data processor incorporating the CPU 1111 and hardware above, to perform the method of the invention.

This signal-bearing media may include, for example, a RAM contained within the CPU 1111, as represented by the fast-access storage for example. Alternatively, the instructions may be contained in another signal-bearing media, such as a magnetic data storage diskette 1300 (FIG. 12), directly or indirectly accessible by the CPU 1111.

Whether contained in the computer server/CPU 1111, or elsewhere, the instructions may be stored on a variety of machine-readable data storage media, such as DASD storage (e.g., a conventional “hard drive” or a RAID array), magnetic tape, electronic read-only memory (e.g., ROM, EPROM, or EEPROM), an optical storage device (e.g., CD-ROM, WORM, DVD, digital optical tape, etc.), paper “punch” cards, or other suitable signal-bearing media including transmission media such as digital and analog and communication links and wireless. In an illustrative embodiment of the invention, the machine-readable instructions may comprise software object code, complied from a language such as “C” etc.

With its unique and novel features, the present invention provides a computer system and method which includes an operation performed in a manner based on a determined activity, which may allow a user to perform an activity more efficiently and effectively.

While the invention has been described in terms of one or more exemplary embodiments, those skilled in the art will recognize that the invention can be practiced with modification within the spirit and scope of the appended claims. Specifically, one of ordinary skill in the art will understand that the drawings herein are meant to be illustrative, and the design of the inventive assembly is not limited to that disclosed herein but may be modified within the spirit and scope of the present invention.

Further, Applicant's intent is to encompass the equivalents of all claim elements, and no amendment to any claim the present application should be construed as a disclaimer of any interest in or right to an equivalent of any element or feature of the amended claim.

What is claimed is:

1. A computer system, comprising:
a determining device for determining an activity of a user; and
a setting device for setting an operating manner of an operating device based on said determined activity.

2. The system of claim 1, wherein said operating device comprises a display device for displaying data,
wherein said setting device configures a display of said data according to said determined activity.

3. The system of claim 2, wherein said determining device determines that another activity is being performed and said setting device reconfigures said display according to said another activity.

4. The system of claim 2, wherein said setting device automatically configures said display according to said determined activity.

5. The system of claim 2, wherein said setting device comprises a selector which selects said display from among a plurality of displays.

6. The system of claim 2, wherein said data comprises a graph.

7. The system of claim 2, wherein said setting device comprises a filter for producing a filtered subset of said data according to said determined activity, and
wherein said display device displays said filtered subset of said data.

8. The system of claim 7, wherein said display comprises a hierarchical organization area which displays said filtered subset.

9. The system of claim 2, wherein said setting device comprises a recommending device for recommending a manner of interacting with said data according to said determined activity, and
wherein said display device displays said recommended manner of interacting with said data.

10. The system of claim 9, wherein said display comprises a recommendation area which displays said recommended manner of interacting with said data.

11. The system of claim 2, wherein said determining device comprises a selector for selecting said activity from among a plurality of activities, and
wherein said display comprises a menu for listing said plurality of activities.

12. The system of claim 2, wherein said determining device comprises an analyzer for analyzing an interaction of said user with said computer system, and outputting said determined activity based on a result of said analyzing.

13. The system of claim 2, wherein said determining device comprises a detector for detecting at least one of a status of said user in a process according to workflow system, and a work item that said user has taken off of a queue.

14. The system of claim 2, wherein said display device comprises a software modeling application for displaying software modeling data.

15. The system of claim 1, wherein said operating manner comprises a response to a user input, and
wherein said setting device comprises a selector for selecting said response to said user input from among a plurality of responses to said user input.

16. The system of claim 15, wherein said selected response to said user input comprises sending a command to another computer system which is connected to said computer system.

17. The system of claim 16, wherein said another computer system comprises an instant messaging server, and
wherein said selected response to said user input comprises sending a command to said instant messaging server for controlling a visibility of said user from said server.

18. A computer method, comprising:
determining an activity of a user; and
setting an operating manner for an operating device based on said determined activity.

19. A programmable storage medium tangibly embodying a program of machine-readable instructions executable by a digital processing apparatus to perform a computer method, said method comprising:
determining an activity of a user; and
setting an operating manner for an operating device based on said determined activity.

20. The method of claim 18, further comprising:
deploying computing infrastructure in which computer-readable code is integrated into a computing system, such that said code and said computing system combine to perform said method.
